(19) United States
(12) Patent Application Publication
(10) Pub. No.: US 2008/0180899 A1
(43) Pub. Date: Jul. 31, 2008

(54) METHODS AND SYSTEMS FOR A MULTI-MEMORY MODULE

(76) Inventors: Roger A. Pearson, Fort Collins, CO (US); Shane Ward, Loveland, CO (US); Noel D. Scott, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,190

(22) Filed: Jan. 31, 2007

(51) Int. Cl. G06F 1/16

(52) U.S. Cl. 361/684

(57) ABSTRACT

A computer system is provided that includes a processor and a memory slot coupled to the processor. The system also includes a multi-memory module attached to the memory slot, the multi-memory module having a plurality of memory sets mounted on a single circuit base. The memory sets are treated as separate memory modules.

### BACKGROUND

Computer systems have a limited number of memory slots. If a user, vendor, or manufacturer wishes to install a lot of memory into a computer system, various problems may arise. For example, installing available memory modules into the limited number of memory slots may not allow sufficient memory to be added to the system. Also, the largest available memory modules tend to use the latest memory technology which usually has a high price premium per bit of memory compared to more mature memory technology.

### BRIEF DESCRIPTION OF THE DRAWINGS

For a detailed description of exemplary embodiments of the invention, reference will now be made to the accompanying drawings in which:

FIG. 1 illustrates a system in accordance with embodiments;

FIG. 2 illustrates another system in accordance with embodiments;

FIG. 3 shows a multi-memory module in accordance with embodiments;

FIGS. 4A-4C illustrate alternative multi-memory modules layouts in accordance with embodiments; and

FIGS. 5A-5F illustrate multi-memory modules having different shapes in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

Embodiments provide methods and systems to implement a circuit base having the components of multiple memory modules. For example, multiple sets of memory buffers with associated memory chips can be assembled onto a single circuit base. Each set is treated as a separate memory module and forms part of a daisy chain. In at least some embodiments, clock circuitry and auxiliary power circuitry are provided on the circuit base to ensure clocking and power needs of the multiple sets are met.

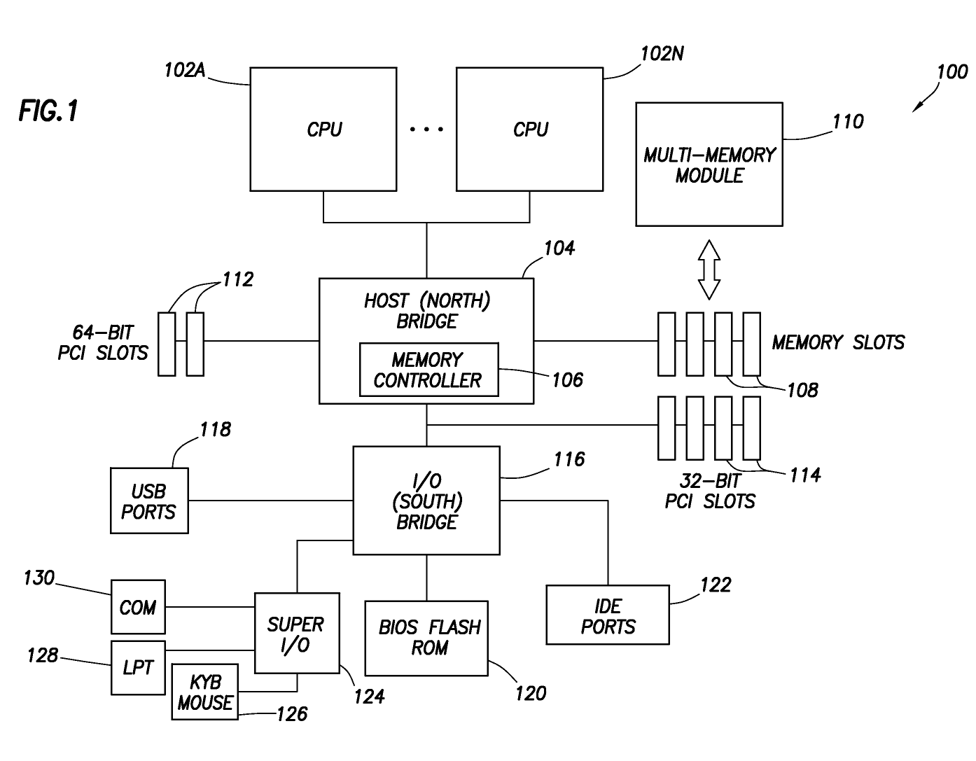

Referring now to the drawings and in particular to FIG. 1, there is shown a computer system 100 in accordance with embodiments. The computer system 100 is only an example and thus embodiments are not limited to FIG. 1. As shown, the computer system 100 comprises at least one host processor (CPU) 102A-102N coupled to a host bridge (sometimes referred to as a “North” bridge) 104. The host bridge 104 comprises a memory controller 106 that enables reads and writes to a multi-memory module 110 which may be, for example, a multiple Dual Inline Memory Module (multi-DIMM). In alternative embodiments, an explicit “bridge” module between the processors and the memory controller in not needed. For example, memory controller circuitry could be integrated with one or more processors on the same semiconductor circuit.

As will later be described, the multi-memory module 110 comprises a circuit base having multiple sets of memory buffers with associated memory chips. Each of the sets is treated as a separate memory module and forms part of a daisy chain.

As shown, the multi-memory module 110 can be inserted into an available memory slot 108 (e.g., a DIMM slot) coupled to the host bridge 104. Although DIMM technology is discussed in illustrated embodiments, other memory technologies now known or later developed could alternatively be assembled and used for a multi-memory module.

The computer system 100 also may comprise other components. For example, peripheral components could be supported by 64-bit Peripheral Component Interconnect (PCI) slots 112 coupled to the host bridge 104 or by 32-bit PCI slots 114 coupled between the host bridge 104 and an input/output (I/O) bridge 116 (sometimes referred to as a “South” bridge). The I/O bridge 116 interfaces the host bridge 104 with a variety of components such as Integrated Drive Electronics (IDE) ports 122, a Basic Input/Output System (BIOS) 120, a Super I/O controller 124 and Universal Serial Bus (USB) ports 118. The Super I/O controller 124 provides an interface for keyboard and mouse ports 126, a parallel port (LPT) 128 and a serial port (COM) 130. Again, FIG. 1 is an example only and other components now known or later developed can additionally or alternatively be part of the computer system 100.

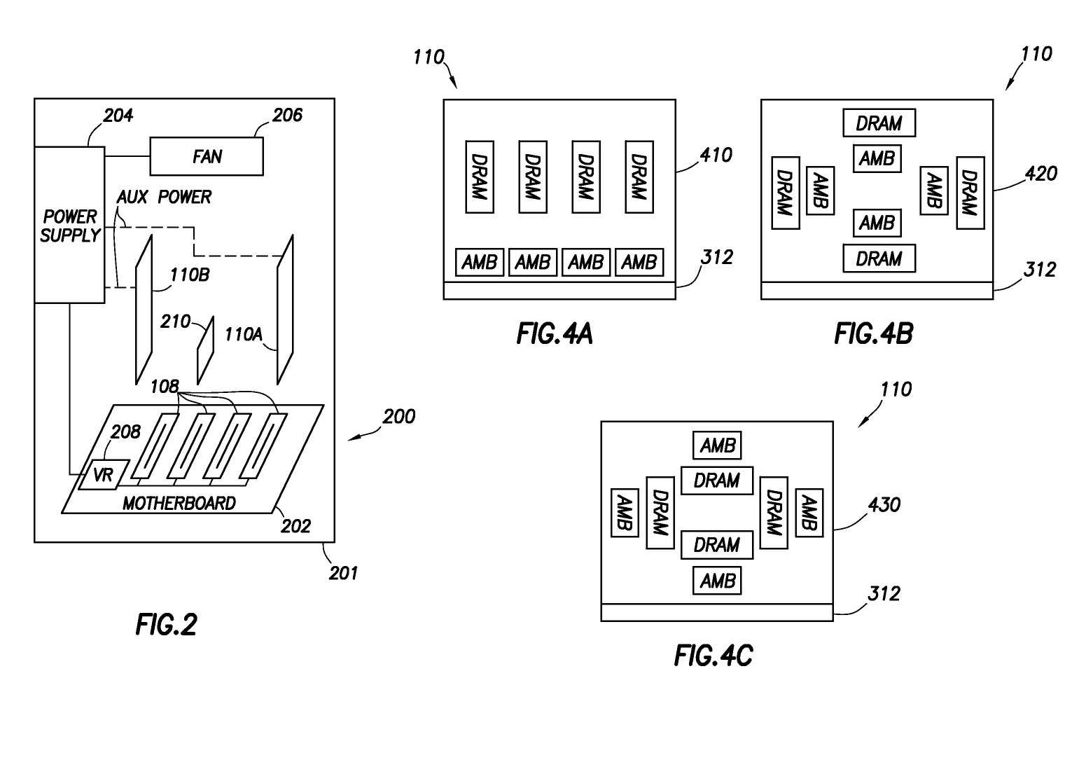

FIG. 2 illustrates another computer system 200 in accordance with embodiments. In at least some embodiments, some or all of the computer system 100 is integrated into the system 200. As shown in FIG. 2, the system 200 comprises several components placed within (inside) a chassis 201. For example, the system 200 may comprise a motherboard 202 having memory slots 108 configured to receive standard memory modules (e.g., DIMM modules). In accordance with embodiments, at least one of the multi-memory modules 110A, 110B is inserted into the memory slots 108. The multi-memory modules 110A, 110B could be inserted into adjacent slots to form a daisy-chain. If a memory slot 108 is skipped, a “filler” or “bypass” board may be inserted into the empty slot to maintain a daisy chain between standard memory modules and/or multi-memory modules 110A, 110B. The multi-memory modules 110A and 110B could be the same or could differ with respect to circuit base size, memory capacity, memory set layout, circuit base shape or other features. As an example, multi-memory module 110A might have two sets of memory buffers and associated memory chips while multi-memory module 110B has four sets of memory buffers and associated memory chips.

In at least some embodiments, standard memory modules (e.g., DIMM modules) 210 or the multi-memory modules 110A, 110B could be inserted into the memory slots 108. The choice to insert standard memory modules 210 and/or certain multi-memory modules 110A, 110B could be based, for example, on space limitations within the chassis 101, memory capacity needs, the number of memory slots 108, cost considerations, motherboard layout, cooling arrangements or other factors.

The system 200 also comprises a power supply 204 that supplies power to the memory slots 108 on the motherboard 202. In at least some embodiments, power from the power supply 204 is regulated by a voltage regulator (VR) 208 on the motherboard 202 prior to being passed to standard memory modules 210 and/or the multi-memory modules 110A, 110B via the memory slots 108. To help with the discussion of powering multi-memory modules, any power received via the memory slots 108 is hereinafter referred to as “slot power.” Because multi-memory modules 110A, 110B have more components than a standard memory module 210, the slot power may be insufficient for powering multi-memory modules 110A, 110B. Thus, in at least some embodiments, auxiliary power is provided to the multi-memory modules 110A, 110B from the power supply 204. The auxiliary power can be provided to each multi-memory module 110A, 110B via an auxiliary connection which is separate from the memory slot connections. For example, at least one of the multi-memory modules 110A, 110B may have power circuitry that receives the auxiliary power and regulates the power for use by components of the multi-memory modules 110A, 110B.

As an example, if multi-memory module 110A has two sets of memory buffers and associated memory chips and multi-memory module 110B has four sets of memory buffers and associated memory chips, then multi-memory module 110B may receive auxiliary power while multi-memory module 110A does not. In some embodiments, the auxiliary power is combined with the slot power to power some or all of the components of the multi-memory module 110B. Additionally or alternatively, the slot power is provided to certain components of the multi-memory module 110B while the auxiliary power is provided to other components.

As shown, the system 200 also comprises a fan 206 or other cooling mechanism within the chassis 201. The fan 206 can be placed above the multi-memory modules 110A, 110B or to the side of the multi-memory modules 110A, 110B and functions to move heat away from the multi-memory modules 110A, 110B or other components inside the chassis 201. In at least some embodiments, the installation of multi-memory modules 110A, 110B in the memory slots 108 functions to increase or maintain a cooling effect of the fan 206 on memory installed in the system 200. As an example, one or two multi-memory modules could be used instead of four standard memory modules 210 to increase a cooling effect of the fan 206. If one multi-memory module replaces four standard memory modules 210, the multi-memory module could potentially be placed more directly in the air flow of the fan 206 than could the four standard memory modules. Also, one or two multi-memory modules could be spaced farther apart in the system 200 than could four standard memory modules 210. Again, fillers could be inserted into empty memory slots 108 as needed.

Installing multi-memory modules 110A, 110B instead of standard memory modules 210 in the system 200 can also reduce system costs. As new generations of memory are introduced by manufacturers, the memory is denser than in previous generations of memory. This new, denser memory is typically more expensive per bit of memory. Therefore, if desired memory capacity for a system can be achieved using less dense and less expensive memory, system costs will be reduced. Multi-memory modules make this possible. As an example, a 4 GB standard DIMM could be manufactured using 512 MB memory chips. In contrast, a 4 GB multi-DIMM could be manufactured using 128 MB memory chips. The comparative cost of using 512 MB memory chips (in the standard DIMM) versus 128 MB memory chips (in the multi-DIMM) could enable a 4 GB multi-DIMM to be less expensive than a 4 GB standard DIMM.

FIG. 3 shows a multi-memory module 110 in accordance with embodiments. Although the multi-memory module 110 is described as a multi-DIMM, other memory technologies now known or later developed could alternatively be used to build a multi-memory module. As show in FIG. 3, the multi-memory module 110 comprises various components mounted on a circuit base 310. The circuit base 310 has an edge connector 312 that is compatible with the memory slot 108. For example, the circuit base 310 could be a printed circuit board (PCB) or another base with printed or non-printed routing. In at least some embodiments, ribbon cable or other cables can be used for routing components on the multi-memory module 110. Some or all of the circuit base 310 could optionally be a flexible material that enables the multi-memory module 110 to be folded into a system as needed.

The multi-memory module components are organized into sets 302A-302D. Set 302A comprises Advanced Memory Buffer (AMB) 306A and associated Dynamic Random Access Memory (DRAM) 304A. Set 302B comprises AMB 306B and associated DRAM 304B. Set 302C comprises AMB 306C and associated DRAM 304C. Set 302D comprises AMB 306D and associated DRAM 304D. Each set may have the same memory capacity or a different memory capacity. Also, the number of sets on the multi-memory module 110 may vary. In at least some embodiments, the number of AMBs on the multi-memory module 110 varies according to different memory controllers or different fully-buffered DIMM specifications of a system.

The sets 302A-302D are controlled in daisy chain fashion with communications being “northbound” or “southbound.” As used herein, “northbound” refers to communications directed towards a memory controller (e.g., reads) and “southbound” refers to communications directed away from a memory controller 106 (e.g., writes). As shown, each AMB comprises a “primary northbound port” (PNP), a “secondary northbound port” (SNP), a “primary southbound port” (PSP) and a “secondary southbound port” (SSP). In at least some embodiments, the southernmost AMB on a multi-memory module does not implement either an SNP or an SSP (i.e., there is no memory “south” of a particular AMB on the multi-memory module).

As an example, if the multi-memory module 110 receives commands/data from the memory controller 106, the AMB 306A receives the commands/data via its PSP. The AMB 102A analyzes the commands/data to determine the target. If the AMB 102A is the target, the commands/data are consumed. Otherwise, the AMB 102A forwards the commands/data via its SSP to the AMB 306B. The AMB 306B receives the commands/data via its PSP and the process is repeated until the commands/data reach the target(s). If the multi-memory module 110 is returning data to the memory controller 106, the data can be received via a SNP and forwarded via a PNP of each AMB until the data reaches the memory controller 106. As shown, the southernmost AMB on the multi-memory module 110 (AMB 306D in FIG. 3) can route southbound commands/data via its SSP to the edge connector 312 for transmission to another component. The southernmost AMB on the multi-memory module 110 (AMB 306D in FIG. 3) may also receive northbound data from the edge connector 312 (i.e., data received from another component) via its SNP. The northbound data is forwarded by a PNP of the southernmost AMB towards the memory controller 106. As previously mentioned, the SSP and SNP of the southernmost AMB could be omitted instead of being routed to the edge connector 312. In still other embodiments, the SSP and SNP of an AMB (e.g., the southernmost AMB) could be routed to another connector 316 on the circuit base 310 so that a plurality of multi-memory modules could be stacked (e.g., end-to-end) and inserted into a single memory slot of a system. Although other arrangements are possible, FIG. 3 shows the additional connector 316 on the side opposite the edge connector 312 to enable end-to-end connections.

In at least some embodiments, an AMB (e.g., the southernmost AMB) selectively routes signals to the additional connector 316 or to the edge connector 312. For example, switching logic 318 may enable a user to select whether signals are routed between the southernmost AMB and the additional connector 316 or between the southernmost AMB and the edge connector 312. In some embodiments, the switching logic 318 automatically detects if a valid module is inserted into the additional connector 316 and responds by routing signals between the southernmost AMB and the additional connector 316 rather than to the edge connector 312. If a valid module is not inserted into the additional connector 316, the switching logic 318 routes signals between the southernmost AMB and the edge connector 312.

In at least some embodiments, not all AMBs on the multi-memory module 110 need to be loaded. For example, at least one AMB and its associated DRAM may be “no-loaded” as long as the set resides at the secondary bus end. Thus, the secondary bus will not be routed to the edge connector 312 nor to the additional connector 316 and any partially loaded multi-memory module effectively ends the memory channel (i.e., no memory downstream from the no-loaded set will be recognized).

In at least some embodiments, the multi-memory module 110 also comprises clock circuitry 308 mounted on the circuit base 310. The clock circuitry 308 buffers a clock signal received via the edge connector 312 and provides clock signals to the various components of the multi-memory module 110.

In at least some embodiments, the multi-memory module 110 also comprises voltage regulation (VR) circuitry 314 mounted on the circuit base 310. The VR circuitry 314 regulates auxiliary power provided to the multi-memory module 110. In at least some embodiments, the auxiliary power is received via a connection that is separate from the standard power connection on the edge connector 312 (i.e., the slot power). The auxiliary power can be combined with the slot power to power some or all of the components of the multi-memory module 110. Additionally or alternatively, the slot power is provided to certain components of the multi-memory module 110 while the auxiliary power is provided to other components.

In FIG. 3, the sets 302A-302D of the multi-memory module 110 are organized with one set above the other on the circuit base 310 with the southernmost set being farthest from the edge connector 312. In alternative embodiments, the sets 302A-302D could be organized differently.

FIGS. 4A-4C illustrate alternative memory module layouts in accordance with embodiments. In FIG. 4A, the multi-memory module 110 comprises a standard edge connector 312 and a circuit base 410 having four sets of components (S1-S4). The AMBs of the four sets are mounted near the edge connector 312 with associated DRAMs mounted above each AMB. In FIG. 4B, the multi-memory module 110 comprises a standard edge connector 312 and a circuit base 420 having four sets of components (S1-S4). The AMBs are mounted in the central area of the circuit base 420 with associated DRAMs mounted nearer to each edge of the circuit base 420. In FIG. 4C, the multi-memory module 110 comprises a standard edge connector 312 and a circuit base 430 having four sets of components (S1-S4). The AMBs are mounted near each edge of the circuit base 430 with associated DRAMs mounted in the central area of the circuit base 430. In FIGS. 4B and 4C, the clock circuitry 308 and/or the VR circuitry 314 could be positioned, for example, in the central area of the circuit bases 420 and 430.

Other multi-memory module layouts are possible with different layouts potentially affecting the quality of data signals and power signals on each multi-memory module. The different layouts also potentially affect how multi-memory modules connect to each other. For example, the southernmost AMB of a multi-DIMM could be positioned on the left, the top or the right of a given circuit base to facilitate routing to and from the additional connector 316 which could be placed on the top, the left, or the right of the given circuit base. As previously mentioned, the additional connector 316 enables another memory module or multi-memory module to be connected to the multi-memory module 110.

In at least some embodiments, the shape and size of the multi-memory module 110 can vary while maintaining the standard edge connector 312 and a single circuit base. In FIG. 3, the multi-memory module 110 is taller than a standard memory module, but maintains the same width and depth. In alternative embodiments, the multi-memory module 110 may be shorter or wider than the embodiment shown in FIG. 3. Furthermore, the shape of the circuit base 310 may be customized to avoid contact with known components in a system.

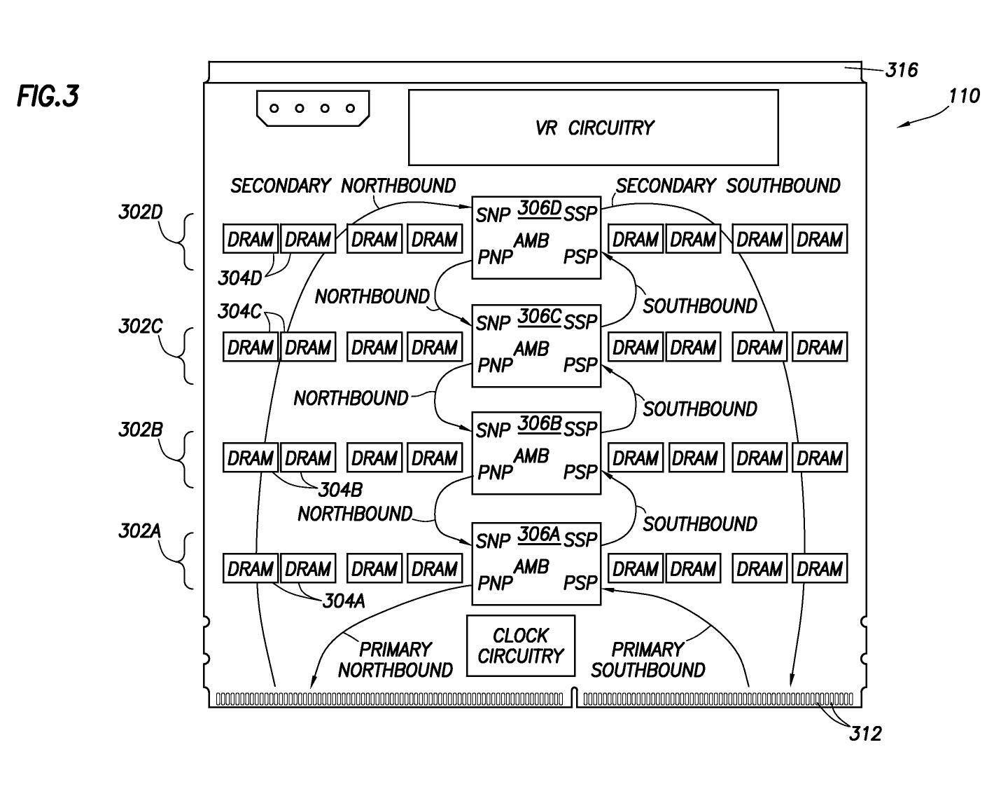

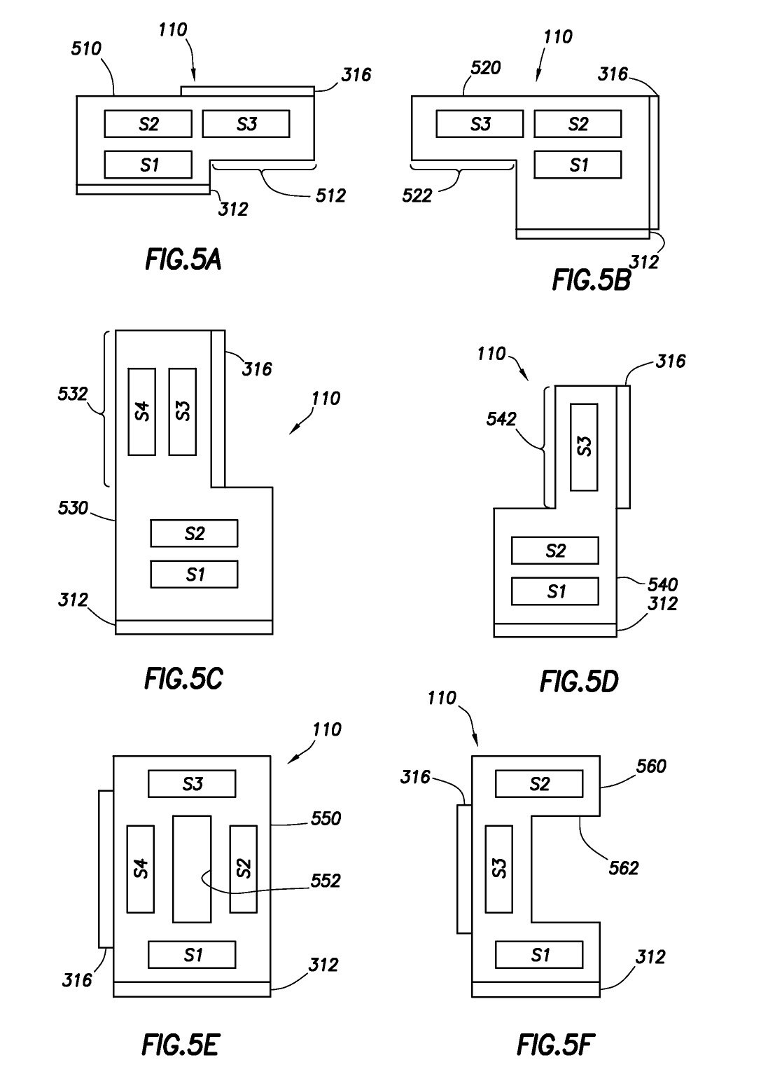

FIGS. 5A-5F illustrate multi-memory modules having different shapes in accordance with embodiments. In FIG. 5A, the multi-memory module 110 comprises a standard edge connector 312 and a circuit base 510 having a portion 512 that extends above and beyond the right side of the edge connector 312. Three sets of components (S1-S3) are mounted on the circuit base 510 and an additional connector 316 is positioned above the portion 512. In at least some embodiments, each of the sets S1-S3 comprise a buffer and associated memory chips. As shown, the portion 512 outlines part of a gap in the circuit base 510 that could enable the multi-memory module 110 to be installed in a system.

In FIG. 5B, the multi-memory module 110 comprises a standard edge connector 312 and a circuit base 520 having a portion 522 that extends above and beyond the left side of the edge connector 312. Three sets of components (S1-S3) are mounted on the circuit base 520 and an additional connector 316 is positioned on the right side of the circuit base 520. In at least some embodiments, each of the sets S1-S3 comprise a buffer and associated memory chips. As shown, the portion 522 outlines part of a gap in the circuit base 520 that could enable the multi-memory module 110 to be installed in a system.

In FIG. 5C, the multi-memory module 110 comprises a standard edge connector 312 and a circuit base 530 having a portion 532 that extends higher on the left side of the circuit base 530. Four sets of components (S1-S4) are mounted on the circuit base 530 and an additional connector 316 is positioned on the right side of the portion 532. In at least some embodiments, each of the sets S1-S4 comprise a buffer and associated memory chips. As shown, the portion 532 outlines part of a gap in the circuit base 530 that could enable the multi-memory module 110 to be installed in a system.

In FIG. 5D, the multi-memory module 110 comprises a standard edge connector 312 and a circuit base 540 having a portion 542 that extends higher on the right side of the circuit base 540. Four sets (S1-S4) of components are mounted on the circuit base 540 and an additional connector 316 is positioned on the right side of the portion 542. In at least some embodiments, each of the sets S1-S4 comprise a buffer and associated memory chips. As shown, the portion 542 outlines part of a gap in the circuit base 540 that could enable the multi-memory module 110 to be installed in a system.

In FIG. 5E, the multi-memory module 110 comprises a standard edge connector 312 and a circuit base 550 having a gap 552 enclosed on four sides by the circuit base 550. The gap 552 could enable the multi-memory module 110 to be installed in a system. Four sets (S1-S4) of components are mounted on the circuit base 550 and an additional connector 316 is positioned on the left side of the circuit base 550. In at least some embodiments, each of the sets S1-S4 comprise a buffer and associated memory chips.

In FIG. 5F, the multi-memory module 110 comprises a standard edge connector 312 and a circuit base 560 having a gap 562 enclosed on three sides by the circuit base 560. The gap 562 could enable the multi-memory module 110 to be installed in a system. Three sets (S1-S3) of components are mounted on the circuit base 560 and an additional connector 316 is positioned on the left side of the circuit base 560. In at least some embodiments, each of the sets S1-S3 comprise a buffer and associated memory chips.

Other multi-memory module shapes are also possible to enable the multi-memory module 110 to avoid contact with known components in a system. Also, a plurality of multi-memory modules having different shapes can be connected (e.g., via an additional connector 316) as needed to provide a desired memory capacity for a system. Also, multi-memory modules may be flexible or semi-flexible to facilitate placement in a system. In at least some embodiments, each multi-memory module or combination of multi-memory modules is prepared according to different system parameters and user requests such as memory controller specifications, chassis size, costs, airflow within chassis, arrangement of internal components, or other parameters.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor; a
memory slot coupled to the processor; and
a multi-memory module attached to the memory slot, the multi-memory having a single circuit base with a plurality of memory sets mounted thereon,
wherein the memory sets are treated as separate memory modules.

2. The computer system of claim 1 wherein each memory set comprises an Advanced Memory Buffer (AMB) and associated Dynamic Random Access Memory (DRAM).

3. The computer system of claim 1 further comprising a memory controller coupled to the processor and the memory slot, wherein the memory controller determines the number of memory sets recognized on the multi-memory module.

4. The computer system of claim 1 wherein circuit base comprises a printed circuit board (PCB) and wherein the plurality of memory sets are connected as a daisy chain by the PCB.

5. The computer system of claim 1 further comprising a power supply, wherein the multi-memory module selectively receives power from the power supply via a memory slot and via an auxiliary power connection of the multi-memory module.

6. The computer system of claim 1 further comprising a cooling mechanism, wherein the multi-memory module selectively replaces other memory modules to improve a cooling effect provided by the cooling mechanism.

7. The computer system of claim 1 further comprising a chassis and internal components fixed within the chassis, wherein the multi-memory module is selectively sized and shaped to avoid contact with the chassis and the internal components.

8. The computer system of claim 1 wherein the multi-memory module comprises an edge connector that couples to the memory slot and comprises an additional connector that selectively couples to another multi-memory module.

9. The computer system of claim 8 wherein southbound signals are selectively routed between a southernmost memory set and the edge connector and between the southernmost memory set and the additional connector.

10. The computer system of claim 8 wherein the connector is selectively located on the multi-memory module adjacent a southernmost memory set.

11. The computer system of claim 1 wherein the circuit base is flexible.

12. A multi-memory module, comprising:
a circuit base having an edge connector; and
a plurality of memory sets mounted on the circuit base, wherein the plurality of memory sets are controlled as separate memory modules.

13. The multi-memory module of claim 12 wherein each memory set comprises an Advanced Memory Buffer (AMB) and associated Dynamic Random Access Memory (DRAM).

14. The multi-memory module of claim 12 further comprising clock circuitry mounted on the circuit base, the clock circuitry enables buffering of a clock signal received via the edge connector for use by the plurality of memory sets.

15. The multi-memory module of claim 12 further comprising power circuitry mounted on the circuit base, the power circuitry enables regulation of an auxiliary power for use by at least one of the memory sets, wherein the auxiliary power is separate from power received via the edge connector.

16. The multi-memory module of claim 12 further comprising an additional connector mounted on the circuit base, the additional connector selectively couples to another multi-memory module.

17. The multi-memory module of claim 16 further comprising switching logic mounted on the circuit base, the switching unit selectively routes signals between a southernmost memory set and the edge connector and between the southernmost memory set and the additional connector.

18. The multi-memory module of claim 16 further comprising logic mounted on the circuit base, the logic detects if a valid memory module is inserted into the additional connector and, if a valid memory module is not detected, routes signals between a southernmost memory set and the edge connector and, if a valid memory module is detected, routes signals between the southernmost memory set and the additional connector.

19. The multi-memory module of claim 16 wherein a southernmost memory set is placed adjacent the additional connector.

20. The multi-memory module of claim 12 wherein the circuit base comprises a portion that extends above and beyond a side of the edge connector for mounting at least one of the memory sets to the circuit base.

21. The multi-memory module of claim 12 wherein the circuit base comprises a portion that extends higher on one side for mounting at least one of the memory sets to the circuit base.

22. The multi-memory module of claim 12 wherein the circuit base has a gap that enables the multi-memory module to be installed in a system.

23. The multi-memory module of claim 12 wherein the circuit base is flexible to enable the multi-memory module to be installed in a system.
